(19) United States
(12) Patent Application Publication
(10) Pub. No.: US 2007/0036527 A1
(43) Pub. Date: Feb. 15, 2007

(54) Optical disc recording and reproducing apparatus and direct copy method thereof

(75) Inventor: Chul Hwan Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/496,589

(22) Filed: Aug. 1, 2006

(30) Foreign Application Priority Data
Aug. 10, 2005 (KR) 2005-73474

(51) Int. Cl. H04N 5/00

(52) U.S. Cl. 386/126

(57) ABSTRACT

An optical disc recording/reproducing apparatus and a direct copy method thereof, the apparatus comprising a first drive to read data in an original disc which is inserted therein; and a second drive to receive total data stored in the original disc when performing direct copy and to record the received data in a recordable disc which is inserted therein.

### CROSS-REFERENCE TO RELATED APPLICATIONS

This application claims the benefit of Korean Patent Application No. 2005-73474, filed on Aug. 10, 2005 in the Korean Intellectual Property Office, the disclosure of which is incorporated herein by reference.

### BACKGROUND OF THE INVENTION

1. Field of the Invention

Aspects of the present invention relate to an optical disc system, and, more particularly, to an optical disc recording/reproducing apparatus and a direct copy method thereof, which are capable of easily performing copy between optical discs which are inserted in two optical disc drives, respectively.

2. Description of the Related Art

An increase of highly efficient storage media, such as a DVD disc, has resulted in an increase in market sales of various DVD-related products, such as a DVD player, a DVD recorder, etc. Of them, a typical example is a hard disk drive (HDD)-installed DVD recorder. The HDD-installed DVD recorder, which was disclosed in Korean Patent No. Pat 2003-0067248, comprises an A/V encoder module and an A/V decoder module, each of which, respectively, encodes and decodes inputted audio and video data to and from an MPEG format; a loader engine comprising an HDD and a DVD drive; and a microprocessor to control each element as described above.

When the HDD-installed DVD recorder copies data stored in a DVD disc (or original disc) to another DVD disc (or a recordable disc), the original disc must first be inserted in the DVD drive to copy the data stored therein to the HDD. Afterwards, the original disc is removed from the DVD drive, and the recordable disc is then inserted to the DVD drive to copy the data stored on the HDD therein.

Therefore, the conventional HDD-installed DVD recorder is inefficient, and the copy procedure complicated and time consuming, as the data stored in the original disc must be temporarily stored in the HDD to be copied to another recordable disc, and the original disc is replaced with the recordable disc in the single DVD drive.

### SUMMARY OF THE INVENTION

Aspects of the present invention provide an optical disc recording/reproducing apparatus which is configured to have two optical disc drives such that a copy operation can be easily performed between the two optical disc drives, and a direct copy method using the optical disc recording/reproducing apparatus.

Another aspect of the present invention provides an optical disc recording/reproducing apparatus and a direct copy method thereof, which are capable of easily and rapidly copying all data in the original disc to a recordable disc when a direct copy is selected.

Additional aspects and/or advantages of the invention will be set forth in part in the description which follows and, in part, will be obvious from the description, or may be learned by practice of the invention.

According to an aspect of the present invention, there is provided an optical disc recording/reproducing apparatus comprising: a first drive to read data in an original disc which is inserted thereto; and a second drive to receive total data stored in the original disc when performing direct copy and to record the received data in a recordable disc which is inserted thereto.

The apparatus may, although not necessarily, perform disc copy such that the total data is copied to the recordable disc, if the original disc is not being reproduced, when the direct copy is performed.

The apparatus may, although not necessarily, perform disc copy or title copy, in which the disc copy indicates that the total data is recorded on to the recordable disc if the original disc is being reproduced, and the title copy indicates that only some titles of the data, according to a user's selection, are copied to the recordable disc.

The second drive may, although not necessarily, format the recordable disc before the data of the original disc is copied to the recordable disc when the disc copy is performed.

The apparatus may, although not necessarily, perform a high speed copy in which the data of the original disc is copied to the recordable disc when the disc copy is performed.

According to an aspect of the present invention, there is provided an optical disc recording/reproducing apparatus comprising: a first drive for reading data stored in an original disc which is inserted therein; a second drive for recording data on to a recordable disc which is inserted therein or for reading data stored in the recordable disc; a reproducing signal processor to read the data read from the original disc and to transmit the data to be recorded on to the recordable disc to a recording/reproducing signal processor; the recording/reproducing signal processor to record the data read from the original disc or the data received from an external signal processor on to the recordable disc, wherein the recording/reproducing signal processor encodes, as necessary, the data received from the first drive or the data received from the external signal processor; and the external signal processor.

The second drive may, although not necessarily, format the reproducible disc, and record the data, which is transmitted from the original disc inserted in the first drive, on to the recordable disc.

According to yet another aspect of the present invention, there is provided a direct copy method of an optical disc recording/reproducing apparatus with a first drive, to which an original disc is inserted, and a second drive, to which a recordable disc is inserted, the direct copy method comprising: determining whether the original disc is being reproduced when performing direct copy; and performing disc copy that the total data of the original disc is copied to the recordable disc, if the original disc is not being reproduced, and performing disc copy or title copy if the original disc is being reproduced, in which the title copy indicates that only some titles in the original disc, according to a user's selection, are copied to the recordable disc.

The method may, although not necessarily, further comprise formatting the recordable disc before the data of the original disc is recorded on to the recordable disc when the disc copy is performed.

The method may, although not necessarily, further comprise performing a high speed copy in which the data of the original disc is copied to the recordable disc when the disc copy is performed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a schematic block diagram of an optical disc recording/reproducing apparatus according to an embodiment of the present invention;

FIG. 2 illustrates a flow chart describing a direct copy method of an optical disc recording/reproducing apparatus of FIG. 1;

FIG. 3 illustrates an image of an OSD screen such that a user can determine whether to start a disc copy;

FIG. 4 illustrates an image of an OSD screen to notify a user of a warning message in which data in a recordable disc will be deleted before the recordable disc is formatted, when disc copy is performed;

FIG. 5 illustrates an image of an OSD screen to allow a user to select disc copy or title copy when a direct copy command is inputted while the original disc is being reproduced;

FIG. 6 illustrates an image of an OSD screen to allow a user to select a title to be copied when title copy is performed; and

FIG. 7 illustrates an image of an OSD screen to allow a user to select high speed copy or normal copy when title copy is performed.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

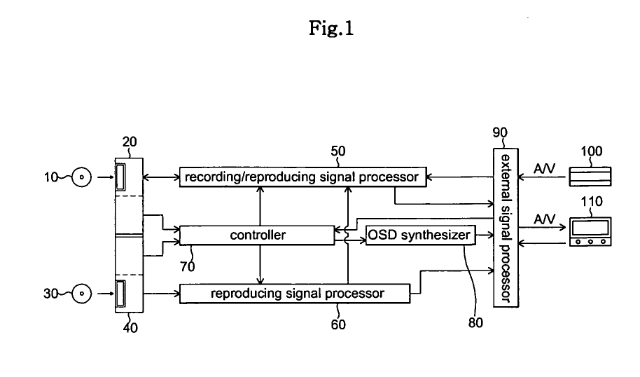

As shown in FIG. 1, the optical disc recording/reproducing apparatus according to an embodiment of the present invention comprises a first DVD drive 40, a second DVD drive 20, a reproducing signal processor 60, a recording/reproducing signal processor 50, an external signal processor 90, an on screen display (OSD) synthesizer 80, and a controller 70.

The first DVD drive 40 receives an original DVD disc 30 therein to reproduce data in the original DVD disc 30. The second DVD drive 20 receives a recordable DVD disc 10 therein to record new data to the recordable DVD disc 10 or to reproduce data in the recordable DVD disc 10. Here, the original DVD disc 30 and the recordable DVD disc 10 may be any of, but not limited to, a DVD-ROM, a DVD-R, a DVD-RW, a DVD-RAM, etc. Furthermore, the apparatus can comprise drives that can accommodate types of optical storage media other than DVDs.

The first DVD drive 40 and the second DVD drive 20 each comprise an optical pick-up and an optical pick-up driver, which are not shown in the drawings, to read/write data from/in the original DVD disc 30 and the recordable DVD disc 10. Here, each optical pick-up comprises a laser diode to emit a laser beam, a photo-detector whose four split optical detection surfaces receive a beam reflected from the DVD disc to convert four split beams to electrical signals, an object lens to collect the laser beam emitted from the laser diode to form a spot on the DVD disc, and actuators to control movement of the object lens.

The reproducing signal processor 60 decodes data read from the first DVD drive 40, based on the MPEG format, when performing a reproduction operation to transmit it to the external signal processor 90. Also, the reproducing signal processor 60 decodes data read from the original DVD disc 30, based on the MPEG format, when performing a normal copy operation to transmit the data to the recording/reproducing signal processor 50. In addition, the reproducing signal processor 60 transmits data read from the original DVD disc 30 to the recording/reproducing signal processor 50, based on an MPEG stream format, when performing a high speed copy operation. Here, the normal copy indicates that copying is performed at a lower speed, such as, but not limited to, 1× speed, and the high speed copying is performed at a higher speed, such as, but not limited to, more than 2× speed.

Similar to the reproducing signal processor 60, the recording/reproducing signal processor 50 decodes data read from the second DVD drive 20, based on the MPEG format, to transmit the data to the external signal processor 90 when performing a reproducing operation. Also, the recording/reproducing signal processor 50 encodes data transmitted from the external signal processor 90, based on the MPEG format, to record the data on to the recordable DVD disc 10. Also, the reproducing signal processor 60 re-encodes data transmitted from the reproducing signal processor 60, based on the MPEG format, when performing a normal copy operation to record the data on to the recordable DVD disc 10. In addition, the reproducing signal processor 60 stores data transmitted from the reproducing signal processor 60, based on MPEG stream format, in the recordable DVD disc 10.

The external signal processor 90 performs NTSC/PAL encoding for data which is decoded, based on the MPEG format, in the reproducing signal processor 60 or the recording/reproducing signal processor 50, and then transmits the data to the TV 110. Also, the external signal processor 90 performs NTSC/PAL encoding on video/audio signals which are inputted from a tuner 100 and then transmits them to the recording/reproducing signal processor 50. In addition, the external signal processor 90 inputs the video and audio signals from the tuner 100 and then transmits the video and audio signals to the TV 110.

The OSD synthesizer 80 generates an OSD image to be displayed on the TV 110 according to a control command of the controller 70, and then transmits the OSD image to the TV 110 through the external signal processor 90. The controller 70 controls all elements of the optical disc recording/reproducing apparatus.

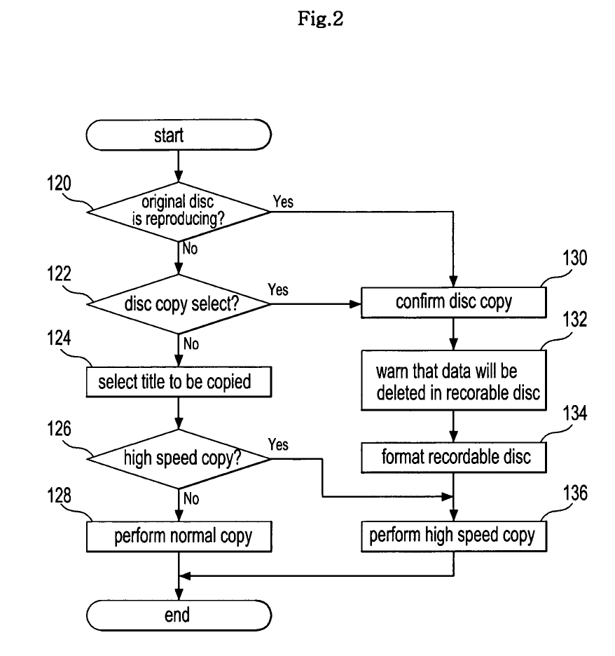

Referring to FIG. 2 to FIG. 7, a direct copy method of an optical disc recording/reproducing apparatus according to an aspect of the present invention will be described as follows. First, the direct copy can perform either a disc copy or a title copy. The disc copy refers to a process where all data stored in the original DVD disc 30 inserted in the first DVD drive 40, which is hereinafter referred to as an original disc 30, is copied to a recordable DVD disc 10 inserted in the second DVD drive 20, which is hereinafter referred to as a recordable disc 10, regardless of a user's selection. On the other hand, title copy refers to a copying such that titles in the original disc are displayed to notify the user and then one or more of the titles, which are selected by the user, are copied.

When a direct copy button (not shown), which may, but not necessarily, be located on a remote controller or a case of the optical disc recording/reproducing apparatus, is operated to perform direct copy, the controller 70 determines whether the original disc 30 is being reproduced in operation 120. When the original disc 30 is not being reproduced, disc copy is performed.

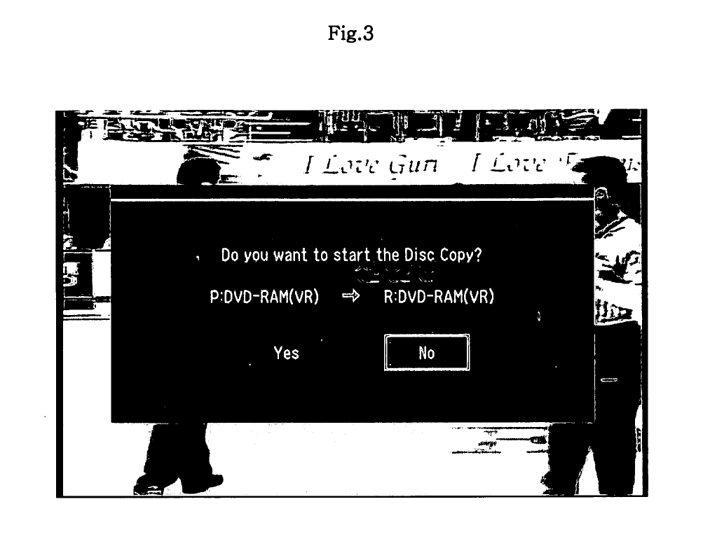

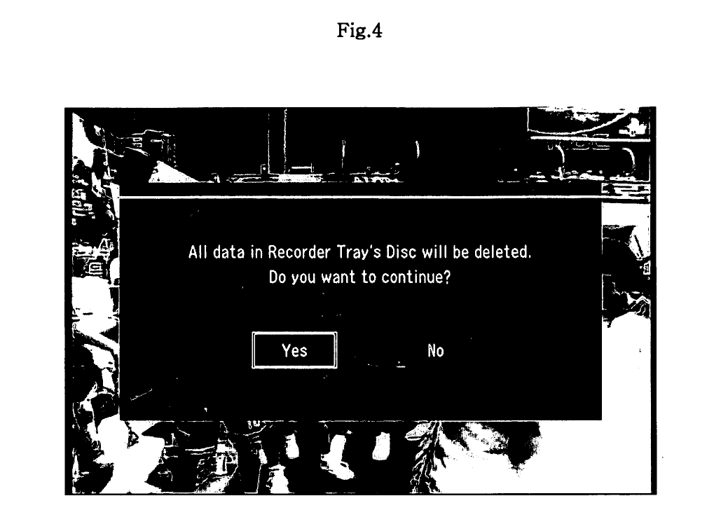

When the disc copy is performed, an OSD screen, as shown in FIG. 3, is displayed on the TV 110 to allow the user to confirm or decline the disc copy, in operation S130. When a negative button (No) on the OSD screen of FIG. 3 is selected using the direction movement button (not shown) and the enter button (not shown) of the remote controller, the disc copy operation is stopped. On the other hand, when a positive button (Yes) on the OSD screen of FIG. 3 is selected, an OSD screen of FIG. 4 is displayed on the TV 110, in operation 132, in which the OSD screen of FIG. 4 includes a warning message indicating that all data will be deleted in the recordable disc 10 when the disc copy is performed. When a negative button (No) on the OSD screen of FIG. 4 is selected, the disc copy is stopped, but when a positive button (Yes) on the OSD screen of FIG. 4 is selected, the second DVD drive 20 formats the recordable disc, in operation 134, and then performs a high speed copy, in operation 136. In a case where the high speed copy is performed, the first DVD drive 40 reads data from the original disc 30 to transmit it to the reproducing signal processor 60, and the reproducing signal processor 60 transmits the data to the recording/reproducing signal processor 50, based on the MPEG stream format. The recording/reproducing signal processor 50 transmits the data of the MPEG stream format to the second DVD drive 20, so that the second DVD drive 20 can store the data in the recordable disc 10.

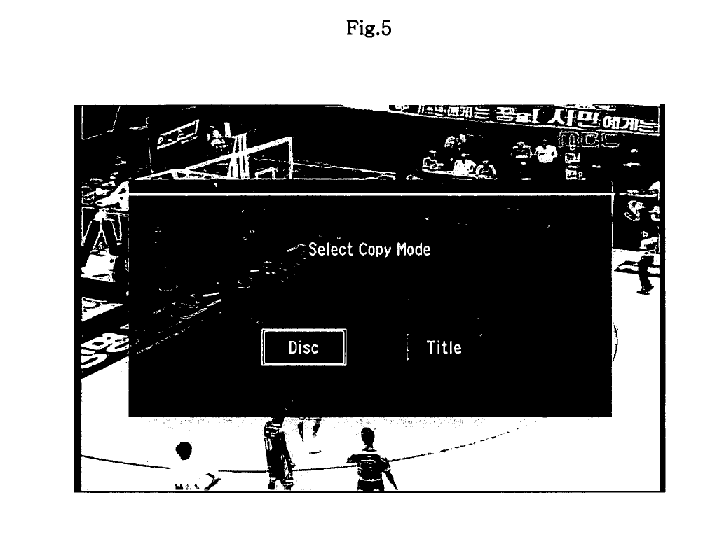

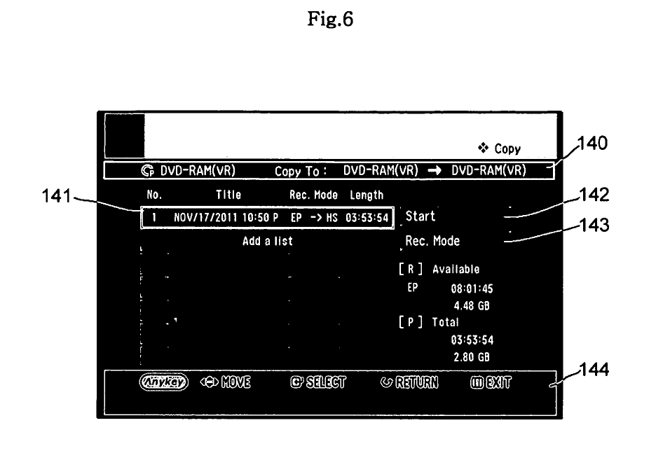

On the other hand, when the determination of operation 120 is positive, or when the original disc 30 is being reproduced, an OSD screen of FIG. 5 is displayed on the TV 110 to allow the user to choose between the disc copy or the title copy. The controller 70 determines whether the disc copy is selected or the title copy is selected, in operation 122. When the user selects the disc copy through the screen of FIG. 5, the controller 70 performs operation 130 and the following operations thereof. On the other hand, when the user selects the title copy, an OSD screen of FIG. 6 is displayed on the TV 110 to allow the user to select titles to be copied. Here, the title copy provides the user various selections such that the disc copy, where all the titles are selected, or the title copy can be performed.

As shown in FIG. 6, the OSD screen is configured such that its upper portion shows a copy direction display region 140 indicating the copy direction from a DVD-RAM to another DVD-RAM, and its middle portion shows a list display region 141 in which title lists to be copied are displayed. When titles to be copied are added, item ‘Add a list’ of the list display region 141 is selected by the enter button, such that desired titles in the title list of the original disc 30 can be selected.

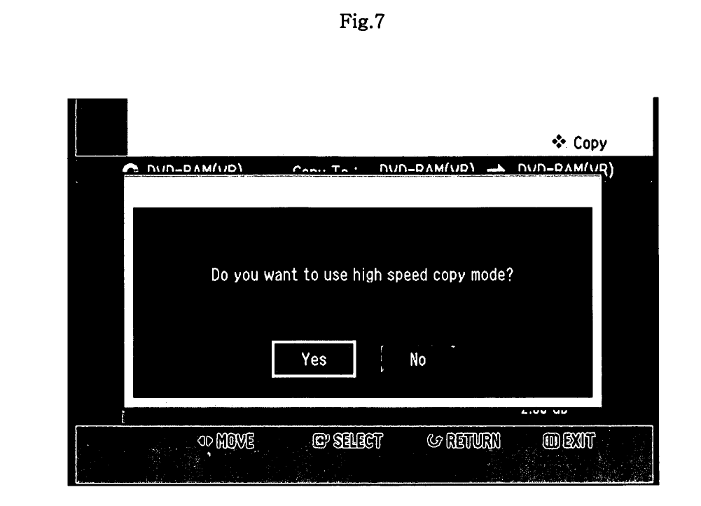

The right portion of the list display region 141 includes a ‘start’ button 142 to input a start command for title copy and a ‘Rec. Mode’ button 143 to set a resolution for recording. The bottom portion of the OSD screen includes an operation display region 144 to display available operations in the presently displayed OSD screen. As shown in FIG. 6, when all titles to be copied are added, in operation 124, and then the ‘start’ button 142 is operated, an OSD screen of FIG. 7 is displayed on the TV 110. FIG. 7 shows an OSD screen for allowing a user to select high speed copy or normal copy when title copy is performed. The controller 70 displays the image of FIG. 7 and then determines whether a high speed copy is selected, in operation 126. When a positive button (Yes) on the OSD screen of FIG. 7 is selected, the controller 70 performs the high speed copy. On the other hand, when a negative button (No) on the OSD screen of FIG. 7 is selected, the controller 70 performs the normal speed copy.

When the normal copy is performed, the first DVD drive 40 reads data from the original disc 30 to transmit it to the reproducing signal processor 60, and the reproducing signal processor 60 performs MPEG decoding of the data to transmit the data to the recording/reproducing signal processor 50 and the external signal processor 90. The recording/reproducing signal processor 50 re-performs MPEG encoding of the data to transmit the data to the second DVD drive 20, such that the second DVD drive 20 can record the data therein. Also, the external signal processor 90 performs NTSC/PAL encoding of the data, which is transmitted from the reproducing signal processor 60, to transmit the data to the TV 110.

The optical disc recording/reproducing apparatus of the present invention performs disc copy if the original disc is not being reproduced, when direct copy is performed. On the other hand, the apparatus performs disc copy or title copy if the original disc is being reproduced. Therefore, the disc copy can be performed when the direct copy is performed, regardless of reproduction of the original disc.

As described above, the optical disc recording/reproducing apparatus of the present invention comprises two DVD drives such that copy operation can be easily performed between optical discs.

Also, the optical disc recording/reproducing apparatus of the present invention can perform high speed copy when direct copy is performed, such that all data of the original disc can be rapidly and easily copied to a recordable disc.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical disc recording/reproducing apparatus comprising:
a first drive to read data stored in an original disc which is inserted therein; and
a second drive to receive the data stored in the original disc when performing a direct copy and to record the received data on to a recordable disc which is inserted therein.

2. The apparatus as claimed in claim 1, wherein if the direct copy is performed, the apparatus performs a disc copy such that all of the data is recorded on to the recordable disc, or a title copy such that one or more titles of the data, according to a user's selection, are recorded on to the recordable disc.

3. The apparatus as claimed in claim 2, wherein if the direct copy is performed and the original disc is being reproduced, the apparatus performs the disc copy or the title copy, according to the user's selection.

4. The apparatus as claimed in claim 2, wherein if the direct copy is performed and the original disc is not being reproduced, the apparatus performs the disc copy.

5. The apparatus as claimed in claim 2, wherein the second drive formats the recordable disc before the data of the original disc is recorded on to the recordable disc when the disc copy is performed.

6. The apparatus as claimed in claim 2, wherein the apparatus performs a high speed copy or a normal copy, wherein the data of the original disc is recorded on to the recordable disc at a faster rate during the high speed copy as compared to the normal copy.

7. The apparatus as claimed in claim 1, further comprising a reproducing signal processor to read the data read from the original disc and to transmit the data to be recorded on to the recordable disc.

8. The apparatus as claimed in claim 7, wherein the reproducing signal processor decodes the data read from the original disc during a normal copy and does not decode the data read from the original disc during a high speed copy, wherein the data read from the original disc is recorded on to the recordable disc at a faster rate during the high speed copy as compared to the normal copy.

9. The apparatus as claimed in claim 7, further comprising an external signal processor, wherein the reproducing signal processor reproduces the first disc by decoding the data read from the first drive and transmitting the data to the external signal processor.

10. The apparatus as claimed in claim 1, further comprising a recording/reproducing signal processor to record the data read from the original disc or data received from an external signal processor on to the recordable disc, wherein the recording/reproducing signal processor encodes, as necessary, the data received from the first drive or the data received from an external signal processor.

11. The apparatus as claimed in claim 10, wherein the recording/reproducing signal processor reproduces the second disc by decoding the data read from the second drive and transmitting the data to an external signal processor.

12. The apparatus as claimed in claim 1, further comprising:
a controller to control all elements of the apparatus; and
an on screen display synthesizer to generate an image to be displayed to a user according to a command of the controller.

13. The apparatus as claimed in claim 1, wherein the first drive and the second drive are DVD drives, and the original disc and the recordable disc are DVD discs.

14. An optical disc recording/reproducing apparatus comprising:
an external signal processor;
a first drive to read data stored in an original disc which is inserted therein;
a second drive to receive the data stored in the original disc when performing a direct copy and to record the received data or data received from the external signal processor on to a recordable disc which is inserted therein;
a reproducing signal processor to read the data read from the original disc and to transmit the data to be recorded on to the recordable disc to a recording/reproducing signal processor; and
the recording/reproducing signal processor to record the data read from the original disc or the data received from an external signal processor on to the recordable disc, wherein the recording/reproducing signal processor encodes, as necessary, the data received from the first drive or the data received from the external signal processor.

15. The apparatus as claimed in claim 14, wherein if the direct copy is performed, the apparatus performs a disc copy such that all of the data is recorded on to the recordable disc, or a title copy such that one or more titles of the data, according to a user's selection, are recorded on to the recordable disc.

16. The apparatus as claimed in claim 15, wherein if the direct copy is performed and the original disc is being reproduced, the apparatus performs the disc copy or the title copy, according to the user's selection.

17. The apparatus as claimed in claim 15, wherein if the direct copy is performed and the original disc is not being reproduced, the apparatus performs the disc copy.

18. The apparatus as claimed in claim 15, wherein the second drive formats the recordable disc before the data of the original disc is recorded on to the recordable disc when the disc copy is performed.

19. The apparatus as claimed in claim 15, wherein the apparatus performs a high speed copy or a normal copy, wherein the data of the original disc is recorded on to the recordable disc at a faster rate during the high speed copy as compared to the normal copy.

20. The apparatus as claimed in claim 14, wherein the reproducing signal processor decodes the data read from the original disc during a normal copy and does not decode the data read from the original disc during a high speed copy, wherein the data read from the original disc is recorded on to the recordable disc at a faster rate during the high speed copy as compared to the normal copy.

21. The apparatus as claimed in claim 14, wherein the reproducing signal processor reproduces the first disc by decoding the data read from the first drive and transmitting the data to the external signal processor.

22. The apparatus as claimed in claim 14, wherein the recording/reproducing signal processor reproduces the second disc by decoding the data read from the second drive and transmitting the data to the external signal processor.

23. The apparatus as claimed in claim 14, wherein the external signal processor encodes data when necessary, transmits data to a television, and inputs data from a tuner to transmit to the recording/reproducing signal processor.

24. The apparatus as claimed in claim 14, further comprising:
a controller to control all elements of the apparatus; and
an on screen display synthesizer to generate an image to be displayed to a user according to a command of the controller.

25. The apparatus as claimed in claim 14, wherein the first drive and the second drive are DVD drives, and the original disc and the recordable disc are DVD discs.

26. A direct copy method of an optical disc recording/reproducing apparatus with a first drive, to which an original disc is inserted, and a second drive, to which a recordable disc is inserted, the direct copy method comprising:
determining whether the original disc is being reproduced when performing direct copy; and
performing a disc copy such that the total data of the original disc is recorded on to the recordable disc, if the original disc is not being reproduced, and performing the disc copy or a title copy such that one or more titles of the data, according to a user's selection, are recorded on to the recordable disc, if the original disc is being reproduced.

27. The method as claimed in claim 26, further comprising formatting the recordable disc before the data of the original disc is recorded on to the recordable disc when the disc copy is performed.

28. The method as claimed in claim 26, further comprising performing a high speed copy or a normal copy, wherein the data of the original disc is recorded on to the recordable disc at a faster rate during the high speed copy as compared to the normal copy.

29. The method as claimed in claim 28, wherein the high speed copy is performed during the disc copy.

30. A controller encoded with instructions to perform the method of claim 26.
